(19) United States
(12) Patent Application Publication
(10) Pub. No.: US 2005/0123397 A1
(43) Pub. Date: Jun. 9, 2005

(54) Compressor diffuser

(76) Inventors: Nathan J. McArdle, Huddersfield (GB); Stephen W. Ellis, Deeside (GB); Steven Don Arnold, Rancho Palos Verdes, CA (US); John F. Allen, El Segundo, CA (US); Kevin Slupski, Redondo Beach, CA (US)

Correspondence Address: Ephraim Starr, Division General Counsel;Honeywell International Inc., Suite #200, 23326 Hawthorne Boulevard, Torrance, CA, 90505, US

(21) Appl. No.: 10/727,845

(22) Filed: Dec. 3, 2003

(51) Int. Cl. F03D 11/00

(52) U.S. Cl. 415/196

(57) ABSTRACT

A compressor diffuser for a vehicle engine turbocharger, the diffuser comprising: a diffuser housing having a gas flow path having a side wall connecting a gas inlet to a gas outlet; a plurality of pivotally mounted diffuser vanes arranged in the flow path to control gas flow, and a vane angle control device for adjusting the angle of each of the plurality of vanes in the flow path; the control device comprising a unison ring coupled to the plurality of vanes in such a way that rotation of the unison ring pivots each of the vanes by interaction of a cam surface with a respective cam follower.

### BACKGROUND AND DESCRIPTION

The present invention relates to a diffuser for a compressor for a vehicle engine turbocharger.

A turbocharger for an internal combustion engine comprises a turbine side receiving exhaust gas from the engine to drive a turbine wheel connected to a shaft on which is mounted a compressor impeller wheel. Exhaust gas from the engine turns the turbine wheel and thus the shaft and causes rotation of the compressor impeller wheel. Intake air is drawn into the impeller wheel and its pressure boosted before it is fed to the engine and mixed with fuel for the combustion process. The increased pressure of the engine intake air increases the performance of the engine.

A turbocharger compressor operates at relatively low temperatures but relatively high pressure (compared to the turbine).

It is important to control the flow of gas in turbochargers to ensure a steady flow and avoid surges and stalls. A diffuser typically is positioned in the flow path from the compressor wheel to the air outlet to control the flow of air by means of vanes in the gas flow path which even out or diffuse the air flow.

These vanes have traditionally been fixed in position. However the applicant has discovered that there are advantages to making these vanes of variable angle so as to better suit the gas flow in the diffuser to the operating conditions of the engine.

According to one aspect of the present invention there is provided a compressor diffuser for a vehicle engine turbocharger, the diffuser comprising: a diffuser housing having a gas flow path having a side wall connecting a gas inlet to a gas outlet; a plurality of pivotally mounted diffuser vanes arranged in the flow path to control gas flow, and a vane angle control device for adjusting the angle of each of the plurality of vanes in the flow path; the control device comprising a unison ring coupled to the plurality of vanes in such a way that rotation of the unison ring pivots each of the vanes by interaction of a cam surface with a respective cam follower.

Preferably the unison ring comprises a substantial part of the flow path side wall, for example 60%, or 70%, or 80%, or 90%.

According to a preferred embodiment of the present invention the unison ring is mounted for rotation in a recess in the diffuser housing such that the side of the ring exposed to the gas path is generally flush with the remainder of the diffuser housing making up the flow path side wall.

Preferably each diffuser vane comprises a leading end and a trailing end and is pivotally mounted about a pivot point close to the leading edge.

Advantageously the unison ring is coupled to the plurality of vanes in such a way that rotation of the unison ring pivots each of the vanes by interaction of a cam surface with a respective cam follower, and the cam follower has a generally elongate oval shape in cross section to engage the cam surface over a contact surface. The cam follower may be formed as a tab on each vane and the respective cam surfaces are formed as an internal surface of an elongate slot in the unison ring. The slot preferably has an arcuate form. The elongate oval shape of the cam follower may comprise a central generally rectangular region and two curved end regions, and a region having a trapezium cross-section formed between the rectangular region and each curved end section, so as to present at least three generally planar sides on each side of the cam follower. The cam surface is preferably contoured to be complementary to the engaging surface of the cam follower so as to maximize the area of the contact surface between the cam and the cam follower. Each vane may have an elongate isosceles triangle shape with the apex of the triangle forming said one end, wherein the angle subtended at the apex of the triangle is between about 5 degrees and 15 degrees, preferably about 10 degrees. At least one side of each vane may be curved or straight. The vane angle control device preferably further comprises a rack and pinion driven crank shaft, and a spring biased variable current solenoid, wherein the crank shaft is coupled to the solenoid via a cam on the crank shaft to provide direct position feedback to the solenoid. Each vane may be pivotally mounted by means of a pivot pin on the vane which engages with a hole in the diffuser housing. The pivot pin may be formed by grinding and may be mounted on the same side of the vane as the cam follower with the pivot pin extending beyond the tab formed by injection moulding.

The invention can provide for a more robust and controllable compressor with better operating conditions and performance.

### BRIEF DESCRIPTION OF THE DRAWINGS

For a better understanding of the present invention and to show how the same may be carried into effect, reference is made to the accompanying drawings in which:

FIG. 1 is a cross-section of a vehicle engine turbocharger compressor incorporating a diffuser according to the present invention;

FIG. 2 is a plan view of a part of the compressor diffuser shown in FIG. 1;

FIG. 3 is a plan view of a vane forming part of the compressor diffuser in FIGS. 1 and 2 illustrating its path of movement;

FIG. 4 is a plan view of an alternative design shape for the vane;

FIG. 5 is a cross-sectional view of the vane of FIG. 3;

FIGS. 6a and 6b are cross-sectional views of alternative arrangements of the vane of FIG. 3.

### DETAILED DESCRIPTION OF THE DRAWINGS

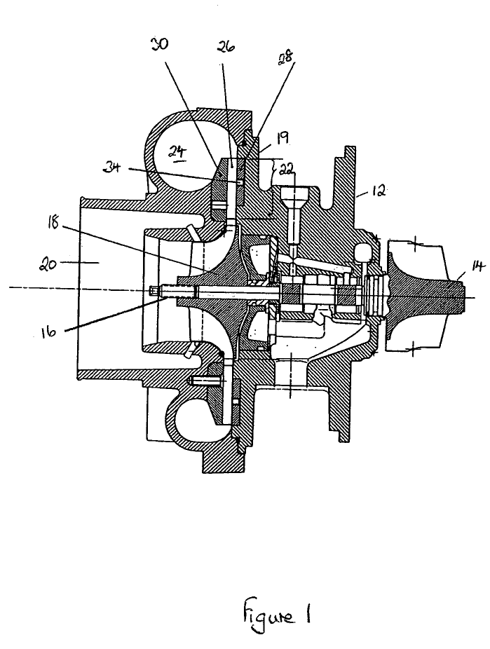

In FIG. 1 a turbine housing 12 is adapted to receive exhaust gas from a vehicle engine and channel the gas to a turbine wheel 14 coupled to one end of a shaft 16. The exhaust gas drives the turbine wheel 14 and thus rotates the shaft 16. The other end of the shaft 16 is connected to a compressor wheel 18, mounted in a compressor housing 19, which rotates with the shaft 16 and draws in air through the intake 20. This air is boosted by the compressor wheel 18 and channeled through a diffuser section 22 of the compressor to an air outlet 24 and thus to the vehicle engine for use in the combustion process.

An arrangement of variable position vanes 26 is disposed in the diffuser section 22 and these cooperate with a unison ring 28 which controls their orientation in the air flow path. The unison ring 28 is rotatably disposed within the compressor housing 19 and is arranged to engage and rotate all of the compressor vanes in unison by cooperation of slots 32 in the unison ring 28 with tabs 34 on the vanes 26 acting as cam members.

The unison ring 28 is set into a recess in the wall of the diffuser section 22 and forms a substantial part of the wall, typically extending for at least 60% of the length of the air flow path in the side wall of the diffuser section, preferably 70%, and more preferably 80%. The unison ring may form up to 90% of the side wall of the diffuser section 22. Since the diffuser effectively has two faces we are referring here to one half of the diffuser wall. This provides for a more robust arrangement and is more cost effective since less parts are required. Also the unison ring 18 has a pressure gradient across it which tends to move it axially toward the vanes 34 thus effectively eliminating any clearance gap between the vane side and the diffuser housing. Such a gap is a source of efficiency loss in known arrangements. The unison ring 18 may effectively be located radially inside of the vanes. It does not open to the gas path, that is to say that its outer peripheral edge is totally located with the recess and the side adjacent the gas path is arranged flush with the rest of the diffuser wall.

The unison ring 18 is a robust and hard wearing item about 2.5 mm thick. A thicker ring tends to reduce the effects of wear through contact but a thinner one reduces wear through vibration.

On the opposite wall of the diffuser section 22 an insert ring 30 is located, again set in an indentation in the compressor housing 19.

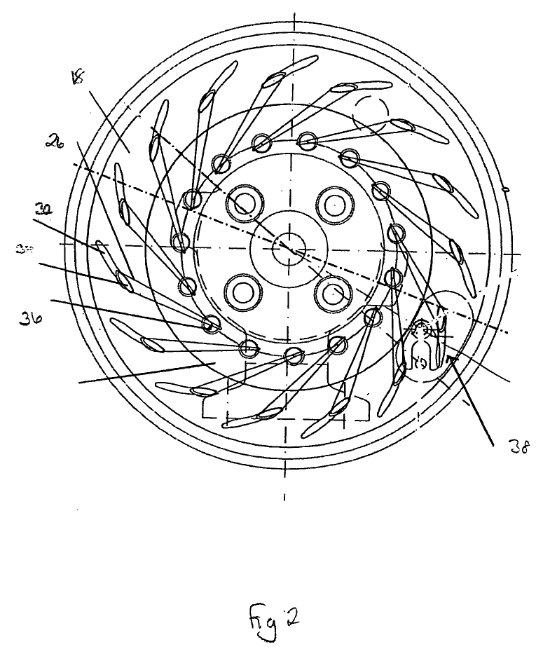

The arrangement of the vanes 26 and the unison ring 28 is shown more clearly in FIG. 2. The vanes 26 are wedge shaped i.e. are relatively narrow tapering triangular members, each pivoted at pivot point 36 close to the apex of the triangle. Each has a tab 34 acting as a cam member to cooperate with the slot 32 on the unison ring 18. Each cam member tab 34 has a relatively large surface area configured to provide a maximum area contact with the slots 32 on the unison ring 18. In particular the tabs 34 are generally larger than pins and has a generally elongate oval shape. The slots 32 are shaped to match the shape of the tabs 34. Such a tab and slot arrangement does not wear out as quickly as a pin and slot arrangement and provides better and more accurate connection and thus more accurate movement of the vanes. The major axis of each tab 34 is set at an inclined angle with respect to the longitudinal axis of each of the vanes 26 and the angle of each slot 32 in the unison ring 18 is adapted accordingly.

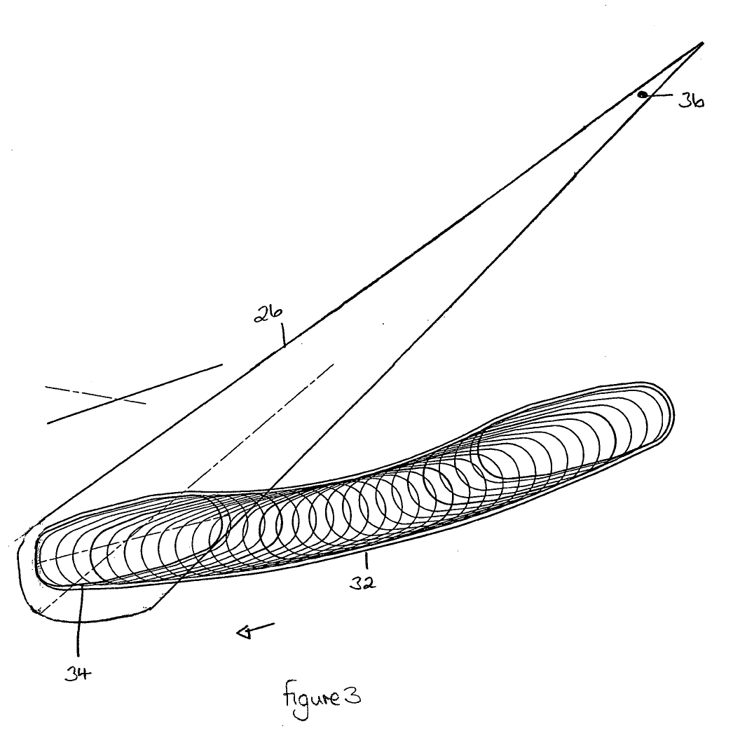

This is shown more clearly in FIG. 3 which illustrates a series of positions which the tab 34 occupies in the slot 32 as it slides along the slot in response to the unison ring being rotated. This pivots the vane 26 about pivot point 36, close to its leading edge.

An alternative shape and configuration of the tabs 34 is shown in FIG. 4 and is described in detail in U.S. Pat. No. 6,269,642 or U.S. Pat. No. 6,419,464 or WO 03/074850 (where the vanes are used in the turbine stage of a turbocharger). In this embodiment the vanes 26 are curved or cambered and take the shape of a fin with a wide end at the trailing edge where the tab 34 is located, tapering to a narrow end at the leading edge where the pivot 36 is located. The tab 34, or cam follower, may be moulded with the vane 26.

The pivot point 36 of each vane 26 is set close to the apex of the triangle so as to decrease the aerodynamic loading on the vane and to ensure higher efficiency. It is generally desired to locate the pivot point of each vane within 10% of the apex and preferably within 10% of the trailing edges of the compressor wheel. This ensures that the leading edge of the vanes 26 is always at approximately the same distance from the compressor wheel 18 regardless of the angle of orientation of the vane and improves performance.

The pivot point 36 of each vane 34 is made as close to the apex of the triangular wedge as is practically possible to assist the aerodynamic loading of the vanes 34, reducing stress on the vanes 34 under high compressor pressures.

The arrangement of the present invention provides a relatively simple and robust operating mechanism with relatively few parts, making it more hard wearing and cost effective to produce and assemble. Control of the vanes is particularly accurate and sensitive since a wider angle of rotation of the unison ring is required for a given rotation of the vanes.

The unison ring 18 is rotated by a crank mechanism 38 to alter the angle of the vanes 34. One possible version of this crank mechanism 38 is described in US 2003/0167767. The crank mechanism 38 is located at the top of the diffuser section 22.

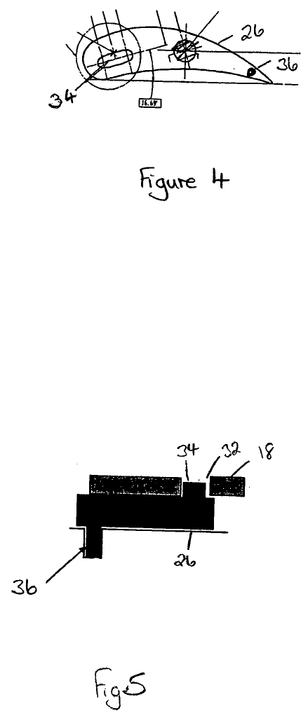

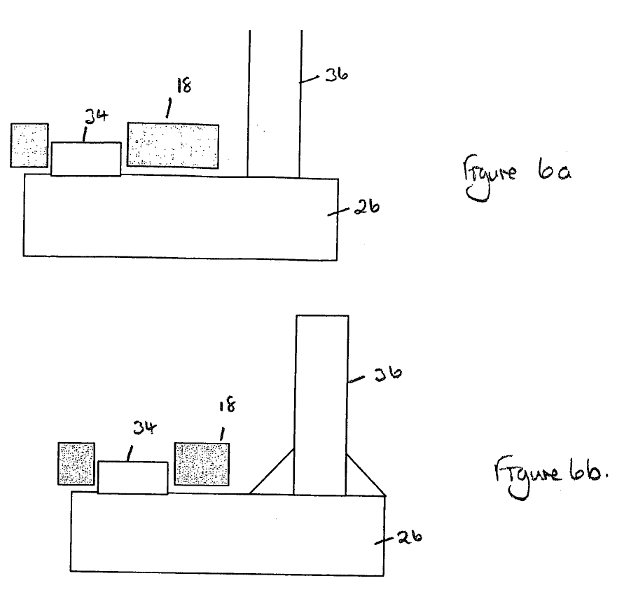

FIG. 5 is a cross-sectional representation of a vane 26 showing the tab 34 close to the trailing edge, engaged in a slot 32 in the unison ring 18. The pivot 36 is close to the leading edge of the vane and is on the opposite side of the vane to the tab 34. However, the pivot pin could be mounted on the same side of the vane as the tab 34 as shown in FIG. 6a, in which the pivot pin 36 is formed integrally with the vane 26, and FIG. 6b, in which the pivot pin 36 is fixed to the vane 26 and less space is available for the unison ring 18.

Adjusting the angle of the vanes 26 in the diffuser by rotating the unison ring 18, causes the diffuser inlet and outlet areas to be adjusted and thus the diffuser flow area can be set at different values to suit different air mass flow rates. This helps to stabilize the diffuser flow and delay a compressor surge and thus extends the operating range of the compressor.

1. A compressor diffuser for a turbocharger, the diffuser comprising:
a diffuser housing having a gas flow path having a side wall connecting a gas inlet to a gas outlet;
a plurality of pivotally mounted diffuser vanes arranged in the flow path to control gas flow,
and a vane angle control device for adjusting the angle of each of the plurality of vanes in the flow path; the control device comprising a unison ring coupled to the plurality of vanes in such a way that rotation of the unison ring pivots each of the vanes by interaction of a cam surface with a respective cam follower.

2. A compressor diffuser according to claim 1 wherein the unison ring comprises a substantial part of the flow path side wall.

3. A compressor diffuser according to claim 2 wherein the unison ring comprises at least 60% of the flow path side wall.

4. A compressor diffuser according to claim 3 wherein the unison ring comprises at least 70% of the flow path side wall.

5. A compressor diffuser according to claim 4 wherein the unison ring comprises at least 80% of the flow path side wall.

6. A compressor diffuser according to claim 5 wherein the unison ring comprises at least 90% of the flow path side wall.

7. A compressor diffuser according to claim 1 wherein the unison ring is mounted for rotation in a recess in the diffuser housing such that the side of the unison ring exposed to the gas flow in the gas path is generally flush with the remainder of the diffuser housing making up the flow path side wall, so that the edge of the ring is not in the flow path.

8. A compressor diffuser according to claim 7 wherein the unison ring is about 2.5 mm thick.

9. A compressor diffuser according to claim 1 wherein each diffuser vane comprises a leading end and a trailing end and each is pivotally mounted about a pivot point close to the leading end.

10. A compressor diffuser according to claim 1 wherein the cam follower has a generally elongate oval shape in cross section to engage the cam surface over a contact surface.

11. A compressor diffuser according to claim 1 wherein the cam follower is formed as a tab on each vane and the respective cam surfaces are formed on the unison ring.

12. A compressor diffuser according to claim 1 wherein each cam surface is formed as an internal surface of an elongate slot in the unison ring.

13. A compressor diffuser according to claim 12 wherein the slot has an arcuate form.

14. A compressor diffuser according to claim 10 wherein the elongate oval shape of the cam follower comprises a central generally rectangular region and two curved end regions.

15. A compressor diffuser according to claim 14 wherein the elongate oval shape of the cam follower further comprises a region having a trapezium cross-section formed between the rectangular region and each curved end section, so as to present at least three generally planar sides on each side of the cam follower.

16. A compressor diffuser according to claim 10 wherein the cam surface is contoured to be complementary to the engaging surface of the cam follower so as to maximize the area of the contact surface between the cam and the cam follower.

17. A compressor diffuser according to claim 1 wherein each vane has an elongate isosceles triangle shape with the apex of the triangle forming said one end.

18. A compressor diffuser according to claim 17 wherein the angle subtended at the apex of the triangle is between about 5 degrees and 15 degrees.

19. A compressor diffuser according to claim 18 wherein the angle subtended at the apex of the triangle is about 10 degrees.

20. A compressor diffuser according to claim 1 wherein at least one side of each vane is curved.

21. A compressor diffuser according to claim 1 wherein the vane angle control device further comprises a rack and pinion driven crank shaft.

22. A compressor diffuser according to claim 21 wherein the vane angle control device further comprises a spring biased variable current solenoid.

23. A compressor diffuser according to claim 22 wherein the crank shaft is coupled to the solenoid via a cam on the crank shaft to provide direct position feedback to the solenoid.

24. A compressor diffuser according to claim 1 wherein each vane is pivotally mounted by means of a pivot pin on the vane which engages with a hole in the diffuser housing, and wherein the pivot pin and the cam follower are mounted on the same side of the vane and the pivot pin extends beyond the tab.

25. A compressor diffuser according to claim 1 wherein the tab is formed by injection moulding.

26. A compressor diffuser for a turbocharger, comprising:
a flow path connecting a gas inlet to a gas outlet defined by a diffuser wall;
a plurality of generally elongate diffuser vanes arranged in the flow path to control gas flow each having a leading end and a trailing end, and each being pivotally mounted about a pivot point close to the leading end;
a vane angle control device for adjusting the angle of each of the plurality of vanes in the flow path;
the control device comprising:
a unison ring connected to the plurality of vanes in such a way that rotation of the ring pivots each of the vanes by interaction of a cam surface with a respective cam follower which has a generally elongate oval shape in cross section to engage the cam surface over a contact surface.

27. A compressor diffuser for a turbocharger, the diffuser comprising:
a diffuser housing having a gas flow path having a side wall connecting gas inlet to a gas outlet; a plurality of pivotally mounted diffuser vanes arranged in the flow path to control gas flow, and a vane angle control device for adjusting the angle of each of the plurality of vanes in the flow path; the control device comprising a unison ring coupled to the plurality of vanes in such a way that rotation of the unison ring pivots each of the vanes, wherein the unison ring comprises a substantial part of the flow path side wall.
